(19) United States
(12) Patent Application Publication
(10) Pub. No.: US 2021/0199582 A1
(43) Pub. Date: Jul. 1, 2021

(54) PRODUCING A COMPOSITE IMAGE OF A STAINED TISSUE SAMPLE BY COMBINING IMAGE DATA OBTAINED THROUGH BRIGHTFIELD AND FLUORESCENCE IMAGING MODES

(71) Applicant: The Regents of the University of California, Oakland, CA (US)

(72) Inventors: Farzad Fereidouni, Sacramento, CA (US); Richard M. Levenson, Davis, CA (US)

(73) Assignee: The Regents of the University of California, Oakland, CA (US)

(21) Appl. No.: 17/057,529

(22) PCT Filed: Jun. 26, 2019
(86) PCT No.: PCT/US19/39323

§ 371 Date: Nov. 20, 2020

Related U.S. Application Data
(60) Provisional application No. 62/691,095, filed on Jun. 28, 2018.

(51) Int. Cl. G01N 21/64; G01N 1/30; G02B 21/00

(52) U.S. Cl. CPC G01N 21/6428; G01N 21/6458; G01N 2021/6441; G02B 21/0076; G01N 1/30

(57) ABSTRACT

The disclosed embodiments relate to a system that produces a composite image of a stained tissue sample by combining image data obtained through brightfield and fluorescence imaging modes. While operating in a brightfield imaging mode, the system illuminates the stained tissue sample with broadband light, and collects image data comprising a brightfield histology image using a multispectral imaging system. While operating in a fluorescence imaging mode, the system illuminates the stained tissue sample with one or more bands of excitation light, and collects image data associated with resulting fluorescence emissions using the multispectral imaging system. Next, the system processes the image data collected during the brightfield and/or fluorescence imaging modes. Finally, the system combines the image data collected during the brightfield and fluorescence imaging modes to produce the composite image.

### RELATED APPLICATION

This application claims priority under 35 U.S.C. § 119 to U.S. Provisional Application No. 62/691,095, entitled “Detecting the Spatial Distribution of Collagen and other Tissue Structural Components on H & E Slides without Additional Stains or Complicated Optics” by the same inventors as the instant application, filed on 28 Jun. 2018, the contents of which are incorporated by reference herein.

### BACKGROUND

### Field

The disclosed embodiments generally relate to techniques for producing images of tissue samples. More specifically, the disclosed embodiments relate to a technique for producing a composite image of a stained tissue sample by combining image data obtained through brightfield and fluorescence imaging modes, wherein the composite image can be used to better visualize structural macromolecule-related tissue components, such as components comprised of collagen.

### Related Art

Collagen is a major component of the extracellular matrix, which in the tumor microenvironment has been implicated in regulating tumor cell behavior, playing an important role in cell adhesion, proliferation, and migration. The type, abundance and alignment of the collagen fibers in proximity to primary breast tumors, in particular, is emerging as a critical stromal feature involved in tumor progression and spread. For example, an initial step in cancer metastasis is the migration of tumor cells through the extracellular matrix and into the lymphatic or vascular systems. In particular, regions of dense collagen are co-localized with aggressive tumor cell phenotypes in numerous solid tumors, including breast, ovarian, pancreatic and brain cancers. However, sparse and aligned collagen fibers at the edges of tumors have also been reported to correlate with aggressive disease. Furthermore, collagen is involved in many other disease processes, including liver and renal fibrosis, and inflammatory bowel disorders.

In order to estimate tissue localization and quantitative expression of connective fibers, it is advantageous to be able to detect collagen distribution in histological specimens. The distribution and quantity of collagen fibers can be assessed using several morphological techniques applied on tissue sections. Among these, histochemistry provides a conventional procedure for detecting total collagen and collagen sub-type tissue content. However, widely used traditional trichrome stains have been found to underestimate collagen content. A better detection technique based on picrosirius red staining has been widely used due to its specificity for most collagen types; therefore, this technique has been largely employed for quantitative estimations of fibrosis in organs, such as liver, lung, kidney and gastrointestinal tract. However, it is not routinely used in clinical histology, and also involves an extra slide and staining step, which increases cost and creates workflow complications and can be problematic for very small specimens.

There exist alternative approaches based on optical techniques that use different phenomena such as second harmonic generation (SHG) or polarization to highlight the collagen. However, SHG is an expensive approach, which requires multi-photon lasers and confocal scanning optics, and is specific to non-centrosymmetric molecules such as collagens I, II, and III and is also highly orientation-dependent. Moreover, generating strong, detectable SHG signals requires some degree of alignment between light polarization and collagen fiber direction and this technique is unable to highlight collagen type IV.

Hence, what is needed is a simple, sensitive, low-cost and non-destructive technique for highlighting macromolecules, such as collagen, in tissue samples.

### SUMMARY

The disclosed embodiments relate to a system that produces a composite image of a stained tissue sample by combining image data obtained through brightfield and fluorescence imaging modes. While operating in a brightfield imaging mode, the system illuminates the stained tissue sample with broadband light, and collects image data comprising a brightfield histology image using a multispectral imaging system. While operating in a fluorescence imaging mode, the system illuminates the stained tissue sample with one or more bands of excitation light, and collects image data associated with resulting fluorescence emissions using the multispectral imaging system. Next, the system processes the image data collected during the brightfield and/or fluorescence imaging modes. Finally, the system combines the image data collected during the brightfield and fluorescence imaging modes to produce the composite image.

In some embodiments, while processing the image data, the system extracts targeted structural macromolecule-related tissue components from background elements in the image data.

In some embodiments, the targeted structural macromolecule-related tissue components include one or more of the following: collagen; basement membrane; elastin; amyloid; lipofuscin; and melanin.

In some embodiments, while processing the image data, the system performs non-component-specific image-processing operations on the image data to improve image quality.

In some embodiments, while performing the non-component-specific image-processing operations, the system performs one or more of the following operations: spectral unmixing; spectral segmentation; color-similarity mapping; and machine-learning-based image-processing techniques.

In some embodiments, while processing the image data, the system generates a targeted-species map from the fluorescence image data. Next, while combining the image data, the system overlays the targeted-species map on the brightfield histology image to generate the composite image, wherein the composite image highlights a presence, an appearance and/or an abundance of targeted molecules.

In some embodiments, while processing the image data, the system performs image-processing operations on the fluorescence image data to improve image quality. Next, while combining the image data, the system combines the processed fluorescence image data with the brightfield histology image to generate the composite image, which provides more information than the brightfield histology image alone.

In some embodiments, the image-processing operations include one or more of the following operations: color inversion; histogram manipulation; autowhite balancing; edge-detection; sharpening; shadowing; and blending.

In some embodiments, the stained tissue sample is stained using one or more of the following: hematoxylin and eosin (H&E); periodic acid-Schiff stain; Verhoeff-Van Gieson stain; reticulin stain; propidium iodide; a fluorescent stain; a lipid stain; a chromogenic immunostain, with a hematoxylin counterstain; a fluorescent immunostain, with a hematoxylin counterstain; a 4′,6-diamidino-2-phenylindole (DAPI) counterstain; a nuclear fast red counterstain; and a fast green counterstain.

In some embodiments, the multispectral imaging system includes a multispectral camera.

In some embodiments, the multispectral imaging system includes multiple cameras.

In some embodiments, the multiple cameras include grayscale and/or color cameras.

In some embodiments, while illuminating the stained tissue sample with the broadband light in the brightfield imaging mode, the system uses a white LED or other broadband source to generate the broadband light, and passes the broadband light through a diffuser or other mechanism to provide illumination for the tissue sample.

In some embodiments, while illuminating the stained tissue sample during the fluorescence imaging mode, the system uses one or more LEDs or other sources to generate the excitation light. Next, the system optionally passes the excitation light through an excitation spectral filter, and optionally uses collimating optics to collimate the excitation light. Finally, the system uses a dichroic beam splitter to direct the excitation light through an objective before illuminating the stained tissue sample.

In some embodiments, during the fluorescence imaging mode, the system generates a fluorescence image with excitation light oriented obliquely toward the stained tissue sample to illuminate the stained tissue sample without passing through an objective lens. Next, the system optionally passes the excitation light through an excitation filter before the excitation light encounters the stained tissue sample. Finally, the system passes resulting fluorescent emission signals through the objective lens and an emission filter before the fluorescent emission signals encounter a sensor in the multispectral imaging system.

In some embodiments, during the fluorescence imaging mode, the excitation light is configured to fall within a spectral range from approximately 300 nm to 800 nm.

In some embodiments, the system generates the excitation light with emission sources, optionally in combination with short-pass, band-pass or multi-band-pass filters, and/or matching dichroic mirrors and emission filters.

In some embodiments, images that comprise the image data are collected sequentially using more than one excitation band.

In some embodiments, during the fluorescence imaging mode, the excitation light, which originates from one or more narrow-band sources, is directed to the stained tissue sample through matching notch dichroic mirrors and emission filters. Next, the system collects the emission light in spectral bands, which have shorter and/or longer wavelengths than corresponding excitation wavelengths.

In some embodiments, the stained tissue sample is mounted on a histology slide, which is held on an x-y stage. During the brightfield and fluorescence imaging modes, the system uses the x-y stage to move the slide to different (x, y) locations, and uses the multispectral imaging system to capture an image of the tissue sample at each different (x, y) location. Next, while processing the image, the system uses stitching and/or alignment software to compose an image of the tissue sample across an entirety of the tissue sample from the images captured at the different (x, y) locations.

In some embodiments, the system feeds the composite image into a machine-learning-based analysis tool to facilitate diagnosis, quantitation and correlation with clinical outcomes.

In some embodiments, the system quantifies targeted component images based on one or more of: abundance, orientation, fiber morphology, texture, and coherency.

In some embodiments, during the fluorescence imaging mode, the system collects broadband image signals using longpass filtering, without subjecting the broadband image signals to band-pass filtering.

In some embodiments, the system displays the composite image through a display system that facilitates toggling among two or more of the composite image, the brightfield histology image, the fluorescence image, and an extracted targeted component image.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1A illustrates a dual-mode imaging system, which combines fluorescence and brightfield imaging modes in accordance with the disclosed embodiments.

FIGS. 1B-1-1B-6 present images of human kidney tissue, breast tissue and liver tissue captured from an FFPE slide stained with H&E in accordance with the disclosed embodiments.

FIGS. 2A-2J present various multispectral and analyzed images of human kidney tissue in accordance with the disclosed embodiments.

FIGS. 3A-3J present various images of human breast tissue, cervical tissue and pancreas tissue in accordance with the disclosed embodiments.

FIGS. 4A-4F present brightfield and extracted collagen images after segmentation for human kidney and liver and also SHG images of tissue samples in accordance with the disclosed embodiments.

FIGS. 5A-5C present H&E, virtual trichrome and real trichrome images of a central vein in human liver tissue in accordance with the disclosed embodiments.

FIG. 6 presents H&E, IHC, virtual and real trichrome images of a tissue sample in accordance with the disclosed embodiments.

FIG. 7 presents a flow chart illustrating the process of producing a composite image of a stained tissue sample by combining image data obtained through brightfield and fluorescence imaging modes in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules. The methods and processes described in the detailed description section can be embodied as code and/or data, which can be stored in a computer-readable storage medium as described above.

### Discussion

Hematoxylin-and-eosin (H&E)-stained slides are a classic means for characterizing histopathological changes in tissue for both clinical and research purposes. It was noted as early as 1969 that the eosin in H&E-stained slides was strongly fluorescent. (See Goldstein, D., The fluorescence of elastic fibres stained with eosin and excited by visible light. The Histochemical Journal, 1969. 1(3): pp. 187-198.) Various reports have since highlighted extra information provided by fluorescence imaging of H&E-stained slides, including: visualizing immunoglobulins in kidney tissue; visualization of the septa in spleen frozen sections; and the evaluation of elastin in arteries with confocal microscopy. Using H&E-stained slides is particularly advantageous because for clinical and research use cases they are almost universally prepared, and typically accompany special or immunohistochemical stains. Fluorescence lifetime imaging is a technique that has been used to image regular H&E slides in fluorescence mode to create a contrast between different macromolecules. This technique has been shown to identify and highlight different tissue components based on their different lifetime values. However, this technique is expensive and complicated and it typically requires pulsed lasers and a confocal microscope setup to generate an image. In an alternative approach, multispectral images of slides in brightfield have been used to identify different components of H&E slides and to extract collagen.

The new imaging technique disclosed in this specification exploits previously unappreciated color differences in H&E fluorescence signals, which have not previously been noted as being informative. The new imaging technique, called “DUal mode Emission Transmission Microscopy” (DUET), highlights the distribution and abundance of collagen or other macromolecules without complicated optics, or additional histochemical or immunohistochemical staining on already prepared H&E slides, based on the color contrast in fluorescence or brightfield mode.

This new technique operates on a new dual-mode imaging system, which combines brightfield and fluorescence imaging modes, and uses a spectral phasor approach or other mathematical methods to extract collagen distributions from fluorescence images. This new technique has tremendous potential for translation into clinical settings, because it facilitates rapid, low-cost collagen and other component imaging using conventional H&E-stained slides. DUET can also be used to advantage with rapid-turn-around time frozen section preparations. Frozen sections are typically deployed in intra-operative situations, or other settings in which histology-based information is required quickly (such as transplant organ candidate evaluation). Special stains are generally not used with frozen sections, since they can take hours to perform. With DUET, a pathologist can evaluate a frozen section rapidly stained with H&E or other appropriate dyes, and gain additional information similar to that obtainable with conventional histochemical collagen, basement membrane and other special stains within the same timeframe as conventional frozen-section analyses.

Before describing the new imaging technique further, we first describe an exemplary dual-mode imaging system on which it operates.

### Dual-Mode Imaging System

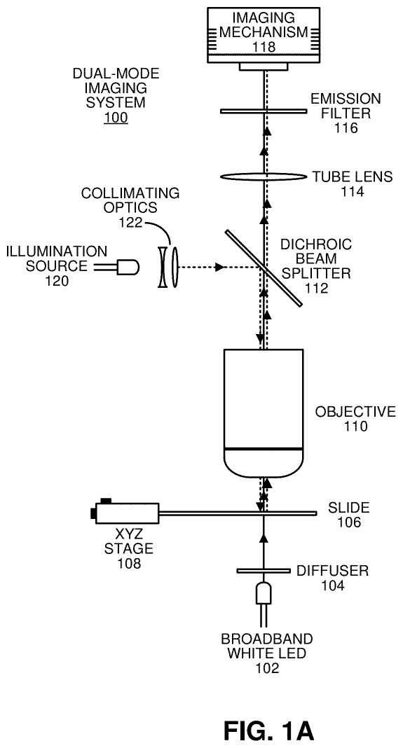

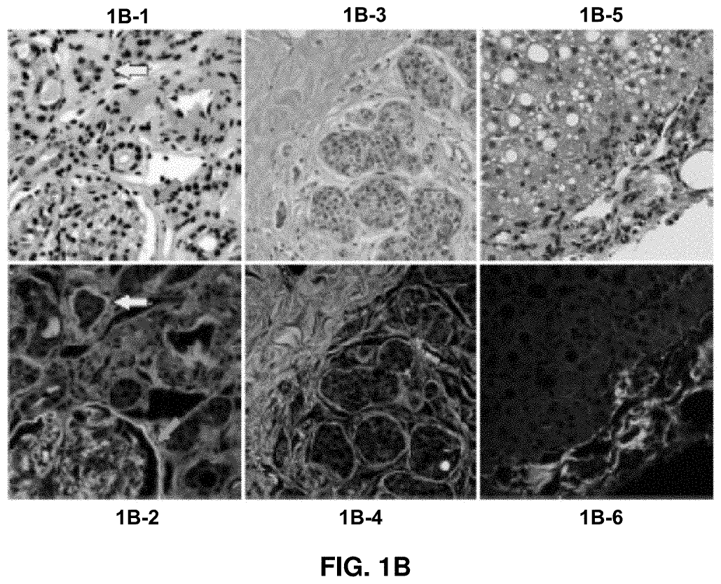

FIG. 1A illustrates a dual-mode imaging system 100, which combines brightfield and fluorescence imaging modes in accordance with the disclosed embodiments. The imaging setup comprises a dual-mode scanner, which uses an illumination source 120 (e.g., a 405 nm UV LED) in epifluorescence mode, and a spectrally broadband white LED 102 in the brightfield imaging mode. The illumination light for fluorescence imaging is guided to the sample through collimating optics 122 and a broadband dichroic beamsplitter 112, and is then focused on a tissue sample located on slide 106 using an objective 110, such as a Nikon objective 10×NA=0.45. Slide 106 is affixed to an XYZ stage 108 with a travel range of 50 mm and 25 mm in x and y directions, and also a limited travel range in the z direction for focusing purposes. The resulting fluorescence emissions from the tissue sample on side 106 are directed back through objective 100 and dichroic beam splitter 112, and then through a tube lens 114 (optional) and an emission filter 116 before being captured by imaging mechanism 118.

In brightfield imaging mode, slide 106 is illuminated from below via a broadband white LED 102 (4500K), which generates reasonably uniform illumination across the visible spectrum. Light from broadband white LED 102 passes through a diffuser 104 and illuminates a sample on slide 106 to facilitate brightfield imaging. The setup can also include a long pass filter 420 LP to reject direct scattering and reflection from the slide while imaging in fluorescence mode. In the brightfield imaging mode, the imaging mechanism 118 provides a scientific-grade color camera (Ximea 9MP), which uses a 200 mm tube lens (Thorlab ILT 200).

In the fluorescence imaging mode, instead of the color camera, imaging mechanism 118 provides a multispectral tunable filter-based camera (Nuance™, Perkin Elmer), wherein multiple images are captured from 420 nm to 720 nm typically in 10-20 nm intervals.

### Data Analysis and Software

Operations related to image acquisition, switching between light sources, stage movement and focusing are controlled through software. Images are also analyzed using a spectral phasor technique, which was previously developed for unmixing or segmentation of multispectral image data. (See Multispectral analysis tools can increase utility of RGB color images in histology. Fereidouni F., Griffin C., Todd A., Levenson R., J Opt. 2018 April; 20(4). pii: 044007. doi: 10.1088/2040-8986/aab0e8. Epub 2018 Mar. 15.) These processes enable the extracted collagen (or other component) image to be highlighted on the brightfield image, and the R, G and B parameters can be changed to create a desired overlay hue.

### The DUET Technique

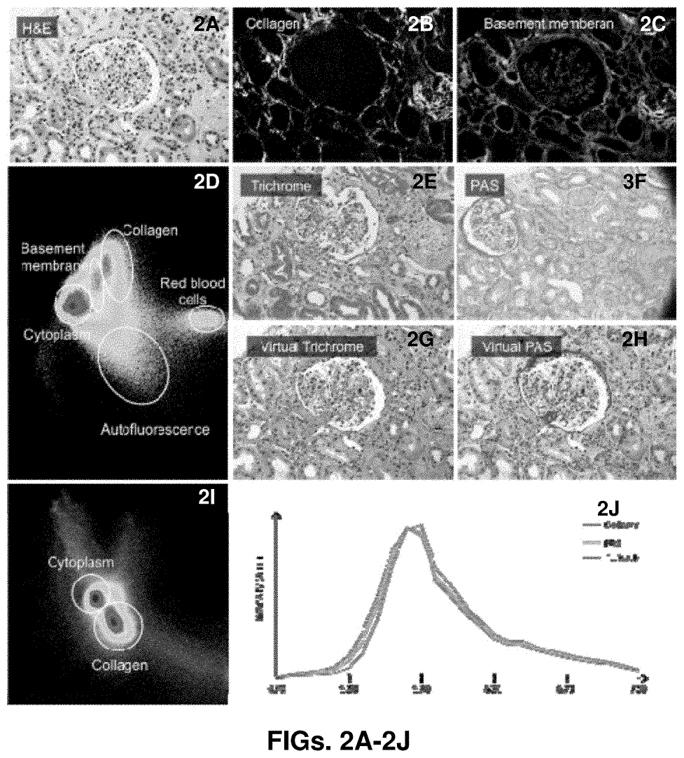

The DUET technique was developed serendipitously while capturing fluorescence images of H&E-stained slides for another purpose. It became apparent that, even when captured just using a color camera, the resulting images contained spectral information that could be used to extract a collagen signal separately from the bulk tissue fluorescence. It was also possible to capture, virtually simultaneously, a high-quality color digital image of the H&E appearance in brightfield (i.e., the familiar histopathology scene). FIGS. 1B-1-1B-6 provide illustrations of this. The brightfield images appear FIGS. 1B-1, 1B-3 and 1B-5, and the fluorescence images appear in FIGS. 1B-2, 1B-4 and 1B-6. To produce these figures, images of human kidney tissue, breast tissue and liver tissue were captured from an FFPE slide stained with H&E in both brightfield and fluorescence imaging modes. As indicated by the yellow and blue arrows in FIGS. 1B-1 and 1B-2, the basement membrane around a tubule is delineated with more contrast on the fluorescence image. Note that collagen-related structures can be observed around the vessel and glomerulus on the fluorescence image that cannot be identified on the brightfield image. Also, note that on the breast tissue images, which appear in FIGS. 1B-3 and 1B-4, the contrast between the collagen and cytoplasm is higher in the fluorescence image in comparison to the brightfield image. The same applies to the liver tissue images, which appear in FIGS. 1B-5 and 1B-6, where it is almost impossible to find the collagen distribution around the central vein in the brightfield image. Closer examination of the fluorescence images reveals that emitted light signals from nuclei in these images are largely absent. This is due to the fact that hematoxylin is not a fluorescent dye.

FIGS. 2A-2J present various multispectral images of human kidney tissue in accordance with the disclosed embodiments. These multispectral images include images acquired during: a fluorescence imaging mode, a brightfield imaging mode and are compared to trichrome images from similar regions (from a serial section). The images were acquired from 420 nm to 720 nm in steps of 15 nm. The stack image was analyzed using a spectral phasor approach, which identified multiple components. After performing an inverse transform over those features by making a region of interest around them, it is possible to identify specific properties that correlate with the presence of collagen, basement membrane, red blood cells, cytoplasm and autofluorescence. FIG. 2A illustrates the brightfield image, FIG. 2B illustrates the unmixed bulk collagen distribution from fluorescence image, FIG. 2C illustrates the basement membrane distribution image, and FIG. 2D the phasor plot created from multispectral fluorescence image. These images are highlighted on the brightfield image to create virtual trichrome and PAS images, which appear in FIGS. 2G and 2H, respectively. The images in FIGS. 2G and 2H can be compared with corresponding images of serial-sectioned slides stained with trichrome and PAS, which appear in FIGS. 2E and 2F, respectively. Also, the spectra of collagen, basement membrane and cytoplasm have been extracted and displayed in FIG. 2D. Note that there exists a very small shift between the spectra of these components as is illustrated by the graph that appears in FIG. 2J, which presents the fluorescence spectra of collagen, basement membrane and cytoplasm. FIG. 2I illustrates a phasor plot from the exact same region captured by a color camera. Although the pixel sizes are not similar, the pixels were binned to get the same resolution and also photon economy. As this phasor plot indicates, cytoplasm and collagen can be easily separated, but it is almost impossible to segment the basement membrane signal with standard RBG sensor acquired images.

### Only Color Camera

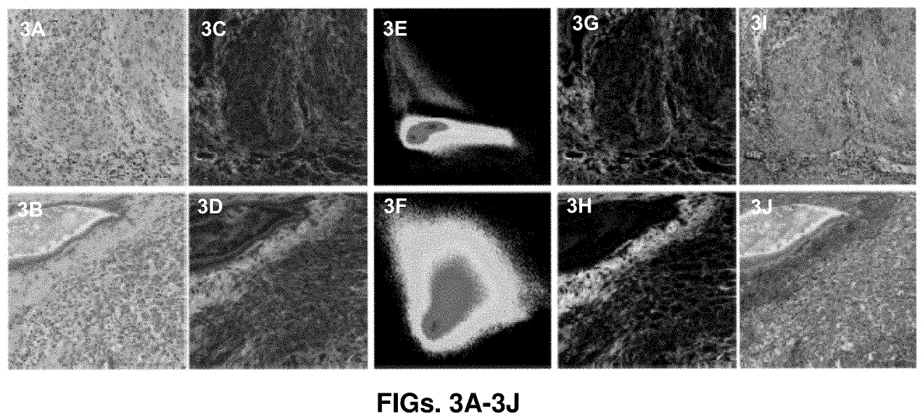

FIGS. 3A-3J present various images of human breast tissue, cervical tissue and pancreas tissue generated with DUET in accordance with the disclosed embodiments. More specifically, FIGS. 3A-3B show the brightfield images and FIGS. 3C-3D show the fluorescence images from the same regions. The corresponding phasor plots are shown in FIGS. 3E and 3F, which highlight two major distributions. Note that performing the inverse transformation from the phasor plot using the region of interest made around the left lobe on the phasor plot segments the collagen-only distribution, which is indicated in FIGS. 3G and 3H. FIGS. 3I and 3J illustrate combined images, which mimic trichrome stain.

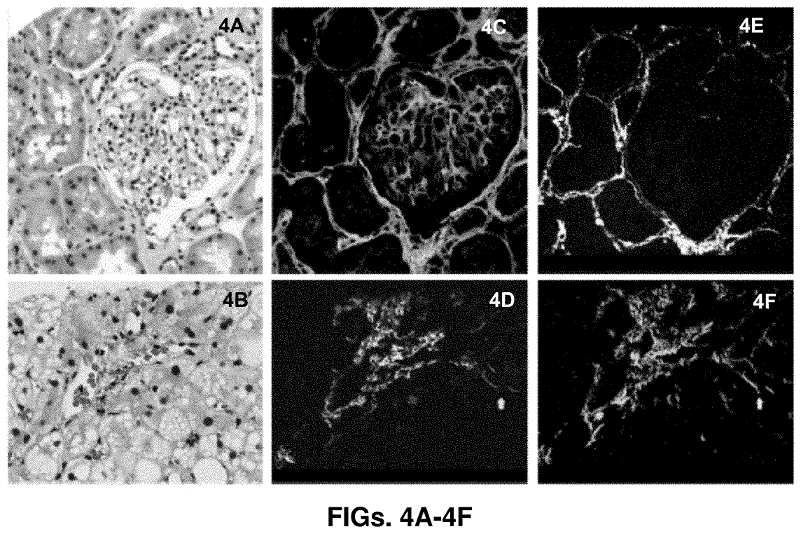

H&E slides of human kidney tissue and liver tissue were imaged using an SHG microscopy system to collect the collagen signal. For the human kidney tissue, FIG. 4A illustrates a brightfield image and FIG. 4C illustrates the extracted collagen distribution image from the fluorescence image. Note that the extracted collagen image in FIG. 4C can be overlaid on the brightfield images in FIG. 4A to generate a virtual trichrome image, which can be compared to serial-sectioned and stained trichrome images from the same region. FIG. 4E illustrates an extracted collagen image using SHG setup from the exactly same region. Note that comparing the collagen distribution extracted from the fluorescence image to the image generated by SHG setup indicates similar distributions except for the signal inside the glomerulus. Moreover, the main constituent inside the glomerulus is type IV collagen. This type of collagen is not birefringent. Therefore, it does not generate any SHG signal under the illumination with femtosecond pulses. FIGS. 4B, 4D and 4F illustrate results for a similar experiment with human liver tissue. In this case, a higher overlap between the DUET signal and SHG signal is observed. Interestingly, the very fine structures observable on the SHG image in FIG. 4D show up nicely on the DUET image in FIG. 4F as is indicated by the yellow arrows.

### Beyond Trichrome

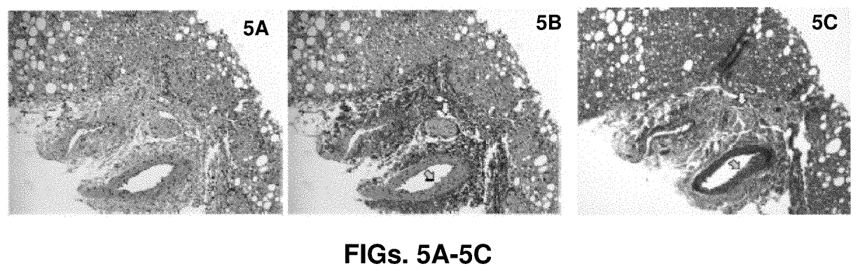

FIGS. 5A-5C illustrate H&E, virtual trichrome and real trichrome images of a central vein in human liver tissue in accordance with the disclosed embodiments. More specifically, FIG. 5A shows the H&E image, FIG. 5B shows the virtual trichrome image, and FIG. 5C shows a corresponding serial-sectioned real trichrome image. Note that while there exists a very good overlap between the virtual and real trichrome images in the regions with authentic collagen (i.e., around the vessels), the virtual trichrome image correctly avoids the false-positive staining of nerve and arteriolar muscle wall seen with the real trichrome stain, as is pointed out by the yellow and green arrows in FIGS. 5B and 5C.

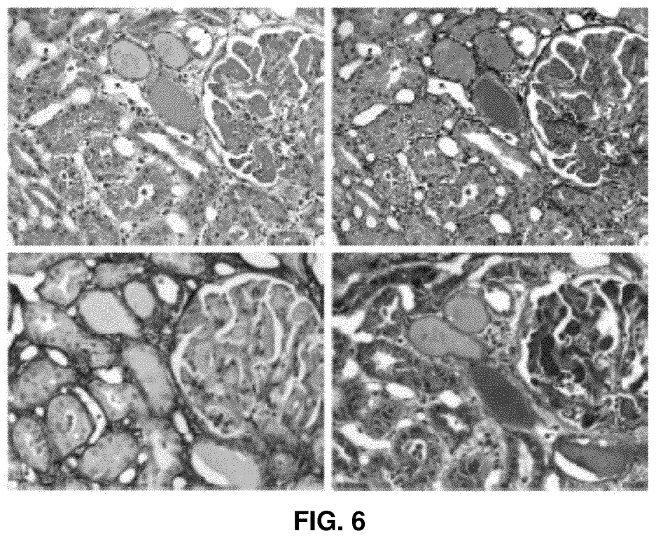

Another interesting example appears in FIG. 6, wherein H&E and trichrome stained images of human kidney are shown. Note that areas of light pink, and dark pink on the H&E slide and light blue and dark blue on the trichrome image correspond with two species of casts, hyaline and granular respectively, which are separable on the virtual trichrome image indicated by orange and green overlays. Fibrin thrombi in the glomerulus can be appreciated in both the virtual and real trichrome images.

### Process for Producing a Composite Image

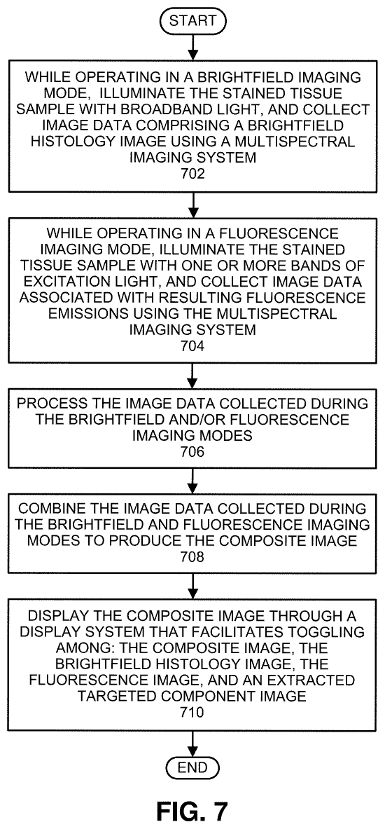

FIG. 7 presents a flow chart illustrating the process of producing a composite image of a stained tissue sample by combining image data obtained through brightfield and fluorescence imaging modes in accordance with the disclosed embodiments. During operation, while operating in a brightfield imaging mode, the system illuminates the stained tissue sample with broadband light, and collects image data comprising a brightfield histology image using a multispectral imaging system (step 702). In contrast, while operating in a fluorescence imaging mode, the system illuminates the stained tissue sample with one or more bands of excitation light, and collects image data associated with resulting fluorescence emissions using the multispectral imaging system (step 704). Next, the system processes the image data collected during the brightfield and/or fluorescence imaging modes (step 706). The system then combines the image data collected during the brightfield and fluorescence imaging modes to produce the composite image (step 708). Finally, the system displays the composite image through a display system that facilitates toggling among: the composite image, the brightfield histology image, the fluorescence image, and an extracted targeted component image (step 710).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

1. A method for producing a composite image of a stained tissue sample by combining image data obtained through brightfield and fluorescence imaging modes, the method comprising:
while operating in a brightfield imaging mode, illuminating the stained tissue sample with broadband light, and collecting image data comprising a brightfield histology image using a multispectral imaging system;
while operating in a fluorescence imaging mode, illuminating the stained tissue sample with one or more bands of excitation light, and collecting image data associated with resulting fluorescence emissions using the multispectral imaging system;
processing the image data collected during the brightfield and/or fluorescence imaging modes; and
combining the image data collected during the brightfield and fluorescence imaging modes to produce the composite image.

2. The method of claim 1, wherein processing the image data involves extracting targeted structural macromolecule-related tissue components from background elements in the image data.

3. The method of claim 2, wherein the targeted structural macromolecule-related tissue components include one or more of the following:
collagen;
basement membrane;
elastin;
amyloid;
lipofuscin; and
melanin.

4. The method of claim 1, wherein processing the image data involves performing non-component-specific image-processing operations on the image data to improve image quality.

5. The method of claim 1, wherein performing the non-component-specific image-processing operations on the image data involves performing one or more of the following operations:
spectral unmixing;
spectral segmentation;
color-similarity mapping; and
machine-learning-based image-processing techniques.

6. The method of claim 1,
wherein processing the image data involves generating a targeted-species map from the fluorescence image data; and
wherein combining the image data involves overlaying the targeted-species map on the brightfield histology image to generate the composite image, wherein the composite image highlights a presence, an appearance and/or an abundance of targeted molecules.

7. The method of claim 1,
wherein processing the image data involves performing image-processing operations on the fluorescence image data to improve image quality; and
wherein combining the image data involves combining the processed fluorescence image data with the brightfield histology image to generate the composite image, which provides more information than the brightfield histology image alone.

8. The method of claim 7, wherein the image-processing operations include one or more of the following operations:
color inversion;
histogram manipulation;
autowhite balancing;
edge-detection;
sharpening;
shadowing; and
blending.

9. The method of claim 1, wherein the stained tissue sample is stained using one or more of the following:
hematoxylin and eosin;
periodic acid-Schiff stain;
Verhoeff-Van Gieson stain;
reticulin stain;
propidium iodide;
a fluorescent stain;
a lipid stain;
a chromogenic immunostain, with a hematoxylin counterstain;
a fluorescent immunostain, with a hematoxylin counterstain;
a 4′,6-diamidino-2-phenylindole (DAPI) counterstain;
a nuclear fast red counterstain; and
a fast green counterstain.

10. The method of claim 1, wherein the multispectral imaging system includes a multispectral camera.

11. The method of claim 1, wherein the multispectral imaging system includes multiple cameras.

12. The method of claim 11, wherein the multiple cameras include grayscale and/or color cameras.

13. The method of claim 1, wherein illuminating the stained tissue sample with the broadband light in the brightfield imaging mode involves:
using a white LED or other broadband source to generate the broadband light; and
passing the broadband light through a diffuser or other mechanism to provide illumination for the tissue sample.

14. The method of claim 1, wherein instead of illuminating the stained tissue sample with the broadband light, the method involves sequentially exposing the stained tissue sample to light of different colors.

15. The method of claim 1, wherein illuminating the stained tissue sample during the fluorescence imaging mode involves:
using one or more LEDs or other sources to generate the excitation light;
optionally passing the excitation light through an excitation spectral filter;
optionally using collimating optics to collimate the excitation light; and
using a dichroic mirror to direct the excitation light through an objective before illuminating the stained tissue sample.

16. The method of claim 1, wherein during the fluorescence imaging mode, the method comprises:
generating a fluorescence image with excitation light oriented obliquely toward the stained tissue sample to illuminate the stained tissue sample without passing through an objective lens;
optionally passing the excitation light through an excitation filter before the excitation light encounters the stained tissue sample; and
passing resulting fluorescent emission signals through the objective lens and an emission filter before the fluorescent emission signals encounter a sensor in the multispectral imaging system.

17. The method of claim 1, wherein during the fluorescence imaging mode, the excitation light is configured to fall within a spectral range from approximately 300 nm to 800 nm.

18. The method of claim 17, wherein the excitation light is generated with emission sources, optionally in combination with short-pass, band-pass or multi-band-pass filters, and/or matching dichroic mirrors and emission filters.

19. The method of claim 17, wherein images that comprise the image data are collected sequentially using more than one excitation band.

20. The method of claim 1,
wherein during the fluorescence imaging mode, the excitation light, which originates from one or more narrow-band sources, is directed to the stained tissue sample through matching notch dichroic mirrors and emission filters; and
wherein emission light is collected in spectral bands, which have shorter and/or longer wavelengths than corresponding excitation wavelengths.

21. The method of claim 1,
wherein the stained tissue sample is mounted on a histology slide, which is held on an x-y stage; and
wherein during the brightfield and fluorescence imaging modes, the method further comprises,
using the x-y stage to move the slide to different (x, y) locations, and using the multispectral imaging system to capture an image of the tissue sample at each different (x, y) location, and
using stitching and/or alignment software to compose an image of the tissue sample across an entirety of the tissue sample from the images captured at the different (x, y) locations.

22. The method of claim 1, wherein the method further comprises feeding the composite image into a machine-learning-based analysis tool to facilitate diagnosis, quantitation and correlation with clinical outcomes.

23. The method of claim 1, wherein targeted component images produced by the method are quantified based on one or more of: abundance, orientation, fiber morphology, texture, and coherency.

24. The method of claim 1, wherein during the fluorescence imaging mode, the method collects broadband image signals using longpass filtering, without subjecting the broadband image signals to band-pass filtering.

25. The method of claim 1, wherein the method further comprises displaying the composite image through a display system that facilitates toggling among two or more of the composite image, the brightfield histology image, the fluorescence image, and an extracted targeted component image.

26. A system that produces a composite image of a stained tissue sample by combining image data obtained through brightfield and fluorescence imaging modes, the system comprising:
a brightfield imaging mechanism that illuminates the stained tissue sample with broadband light, and collects image data comprising a brightfield histology image using a multispectral imaging system;
a fluorescence imaging mechanism that illuminates the stained tissue sample with one or more bands of excitation light, and collects image data associated with resulting fluorescence emissions using the multispectral imaging system;
a processing mechanism that processes the image data collected during the brightfield and/or fluorescence imaging modes; and
a combining mechanism that combines the image data collected during the brightfield and fluorescence imaging modes to produce the composite image.

27. The system of claim 26, wherein while processing the image data, the processing mechanism extracts targeted structural macromolecule-related tissue components from background elements in the image data.

28. The system of claim 27, wherein the targeted structural macromolecule-related tissue components include one or more of the following:
collagen;
basement membrane;
elastin;
amyloid;
lipofuscin; and
melanin.

29. The system of claim 26, wherein processing the image data involves performing non-component-specific image-processing operations on the image data to improve image quality.

30. The system of claim 26, wherein performing the non-component-specific image-processing operations on the image data involves performing one or more of the following operations:
spectral unmixing;
spectral segmentation;
color-similarity mapping; and
machine-learning-based image-processing techniques.

31. The system of claim 26, wherein the stained tissue sample is stained using one or more of the following:
hematoxylin and eosin;
periodic acid-Schiff stain;
Verhoeff-Van Gieson stain;
reticulin stain;
propidium iodide;
a fluorescent stain;
a lipid stain;
a chromogenic immunostain, with a hematoxylin counterstain;
a fluorescent immunostain, with a hematoxylin counterstain;
a 4′,6-diamidino-2-phenylindole (DAPI) counterstain;
a nuclear fast red counterstain; and
a fast green counterstain.

32. The system of claim 26, wherein during the fluorescence imaging mode, the excitation light is configured to fall within a spectral range from approximately 300 nm to 800 nm.

33. The system of claim 26,
wherein the stained tissue sample is mounted on a histology slide, which is held on an x-y stage; and
wherein during the brightfield and fluorescence imaging modes, the system,
uses the x-y stage to move the slide to different (x, y) locations, and uses the multispectral imaging system to capture an image of the tissue sample at each different (x, y) location, and
uses stitching and/or alignment software to compose an image of the tissue sample across an entirety of the tissue sample from the images captured at the different (x, y) locations.

34. The system of claim 26, wherein the system further comprises a machine-learning-based analysis tool, which analyzes the composite image to facilitate diagnosis, quantitation and correlation with clinical outcomes.

35. The system of claim 26, wherein the system further comprises a display system that displays the composite image, wherein the display system facilitates toggling between one or more of the composite image, the brightfield histology image, the fluorescence image, and an extracted targeted component image.

36. A method for producing an image of a stained tissue sample from data obtained through fluorescence imaging, the method comprising:
illuminating the stained tissue sample with one or more bands of excitation light;
collecting image data associated with resulting fluorescence emissions using a multispectral imaging system;
processing the image data by extracting targeted structural macromolecule-related tissue components from background elements in the image data.

37. The method of claim 36, wherein the targeted structural macromolecule-related tissue components include one or more of the following:
collagen;
basement membrane;
elastin;
amyloid;
lipofuscin; and
melanin.
